(19) United States
(12) Patent Application Publication
(10) Pub. No.: US 2009/0064732 A1
(43) Pub. Date: Mar. 12, 2009

(54) TWO-WAY OPENED PADLOCK

(76) Inventor: CHIEN-YUNG HUANG, Banchiao City (TW)

Correspondence Address: PRO-TECHTOR INTERNATIONAL SERVICES, 20775 NORADA CT., SARATOGA, CA, 95070, US

(21) Appl. No.: 12/196,289

(22) Filed: Aug. 22, 2008

(30) Foreign Application Priority Data
Sep. 7, 2007 (TW) 096215044

(51) Int. Cl. E05B 37/00

(52) U.S. Cl. 70/21

(57) ABSTRACT

A two-way opened padlock, having a block in the housing, the padlock enabling the dials of the housing to open and close the lock, a key can also be used to rotate the tumbler to enable force opening of the lock, when the dials are in an unlocked state, a rod moves relative to the housing, a block being also moves relative to the housing, and a rod and a block can move in the same direction.

### BACKGROUND OF THE INVENTION

a) Field of the Invention

The present invention relates to a two-way opened padlock, and more particularly to a padlock not only enable using dials to open and close the lock, a key can also be used to rotate the tumbler to force unlocking.

b) Description of the Prior Art

A conventional combination padlock only uses a correct combination of numbers on dials to enable opening or closing of the lock, and is not provided with a device to force unlocking, such that an auditor or an inspector has no other way to open the lock to examine or audit. Hence, there is a need for improvement in the prior art.

### SUMMARY OF THE INVENTION

The primary object of the present invention is to provide a two-way opened padlock, wherein, a padlock with a block in a housing, the block and a rod enables moving the same direction, apart from the padlock enabling dials of a housing to open and close the lock, a key can also be used to rotate a tumbler to enable a force opening of the lock with the dials are in a locked position, thereby providing the present invention with double opening the lock effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a front elevational view of the present invention.

FIG. 2 is a rear elevational view of the present invention.

FIG. 3 is an exploded perspective view of the present invention.

FIG. 4 is a rear sectional view of the present invention when in a locking position.

FIG. 5 is a rear sectional view of the present invention when in a unlocking position.

FIG. 6 is a rear sectional view of the present invention when in a locking position, and with the lock opened by a key.

FIG. 7 shows a rear sectional view of the embodiment according to the present invention when in a locking position.

FIG. 8 shows a rear sectional view of the embodiment according to the present invention when in a unlocking position.

FIG. 9 shows a rear sectional view of the embodiment according to the present invention when in a locking position, and with the lock opened by a key.

### DETAILED DESCRIPTION OF THE PREFERRED EMBODIMENTS

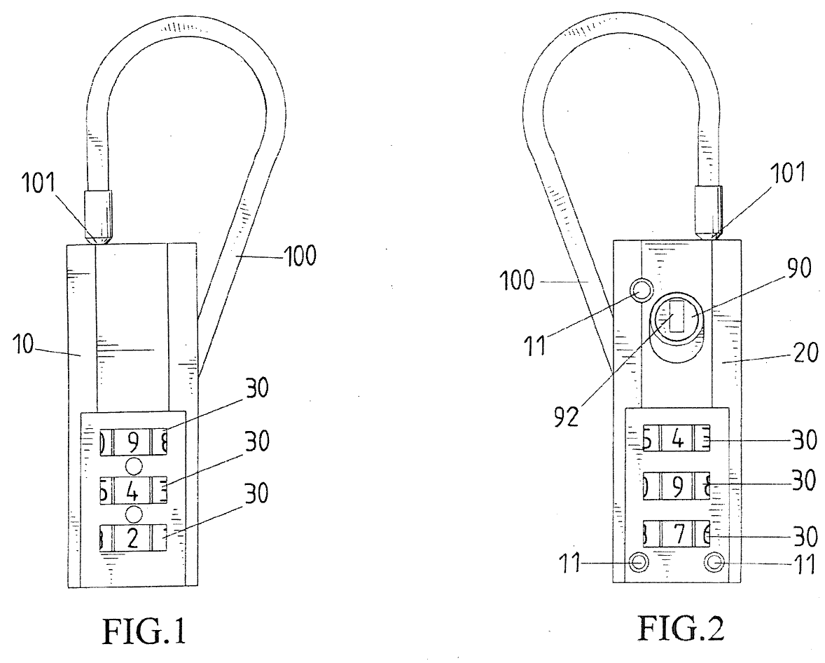

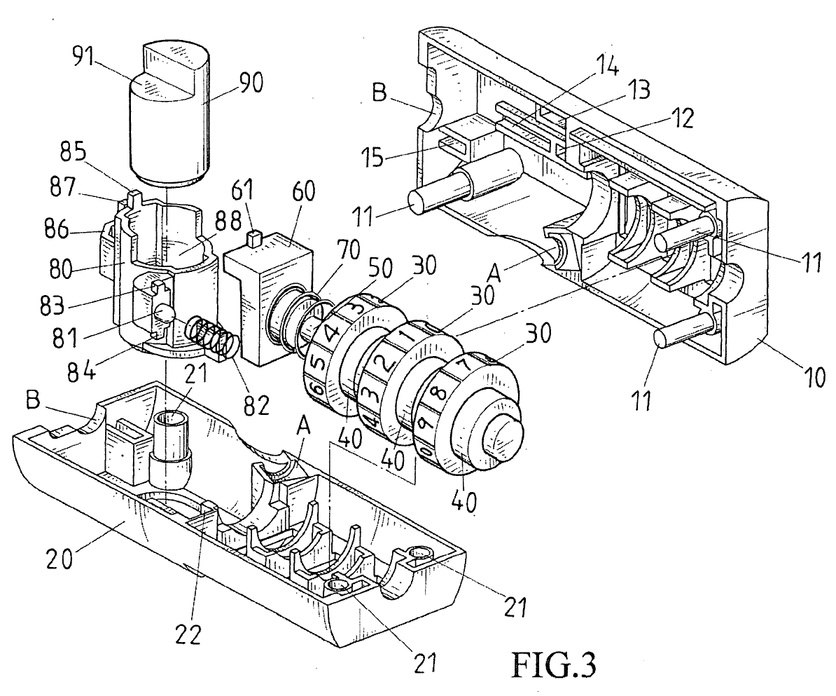

Referring to FIGS. 1 to 3, the present invention comprises two half housings 10, 20, three dials 30, three sleeves 40, a rod 50, a tongue 60, a spring 70, a block 80 and a tumbler 90; wherein a cable 100 is latched in the cable hole A of the housing 10, and the other end of cable 100 is provided with a bolt 101 for locked on the lock hole B of the top end of the housing 10.

A pin 11 of the housing 10 can be locked with a lock hole 21 of the housing 20, exterior sides of the sleeves 40 are sheathed with the dials 30, with outer rims of the dials 30 being exposed out of the housing 10, and an interior of the dials 30 being provided with a center hole to allow the sleeves 40 to insert, and an interior of the sleeves 40 being provided with a center hole to allow the rod 50 to pass therethrough, after a top end of the rod 50 is sheathed with the spring 70, the rod 50 is connected with a tongue 60, the tongue 60 is provided with a bump 61, the bump 61 enables displacing in the runner 12 of the housing 10.

The present invention is primarily characterized in that: a block 80 and a rod 50 can move in the same direction, a bump 81 is located on the end of the block 80, the bump 81 passes through a small spring 82, the other end of small spring 82 being abutted at the spring seat 22 of the housing 20, and a top end of the bump 81 is provided with a rod 83 to enable displacing in the runner 12 of the housing 10, a bottom end of the block 80 is provided with a rod 84 to enable displacing in the runner of the housing 20 (not shown in the drawings), and the rod 85 located at a top end of the block 80 enables displacing in the other runner 14 of the housing 10, the exterior sides of the block 80 is provided with a slant surface 86, the top end of the slant surface 86 is provided with a rod 87 to enable displacing in the other runner 15 of the housing 10, a tumbler hole 88 of the central block 80 to enable the tumbler 90 complaced, the top end of the tumbler 90 is provided with a cutting 91, the cutting 91 enabling the front end of the L-shaped tongue 60 complaced, the other end of the tumbler 90 is provided with a key hole 92 (as shown in FIG. 2).

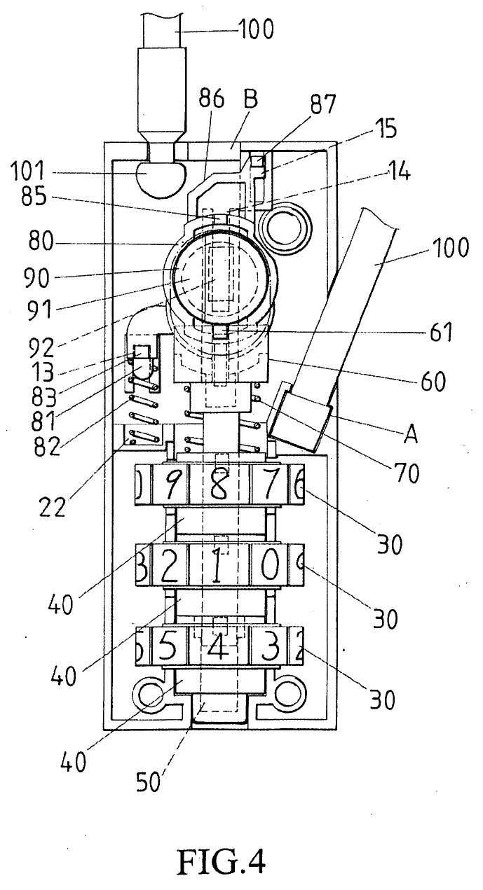

Referring to FIG. 4, the dials 30 are in an unlocked state and the other end of cable 100 is provided with a bolt 101 for locked on the lock hole B of the top end of the housing 10, the cable 100 can not be deviated block 80 to displace, the spring 70-82 can not be squeezed.

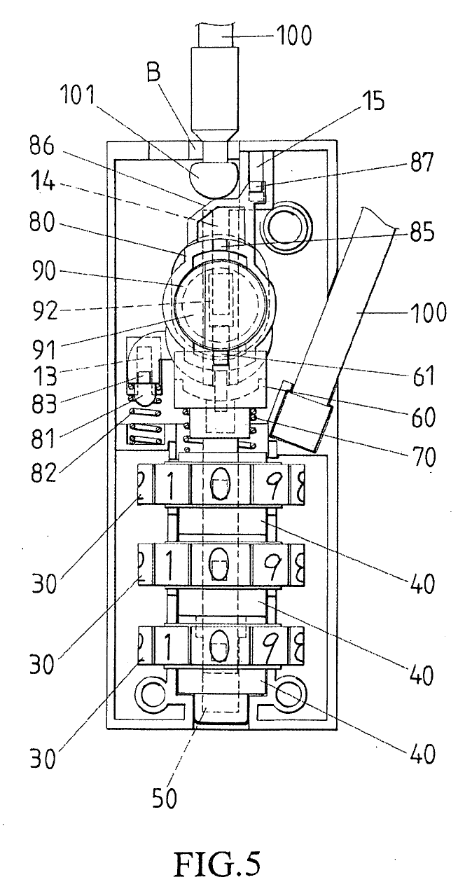

Referring to FIG. 5, the dials 30 are in an unlocked state and the bolt 101 of the cable 100 is deviating the slant surface 86 of the block 80, and drive the block 80 to displace, and the bolt 101 is moving to the lock hole B of the housing 10, and the rod 50 is moved by the block 80 and the spring 70-82 are squeezed, the bolt 101 of the cable 100 can be leaved the housing 100 and opening the lock, the moving directions of both the block 80 and the rod 50 are the same.

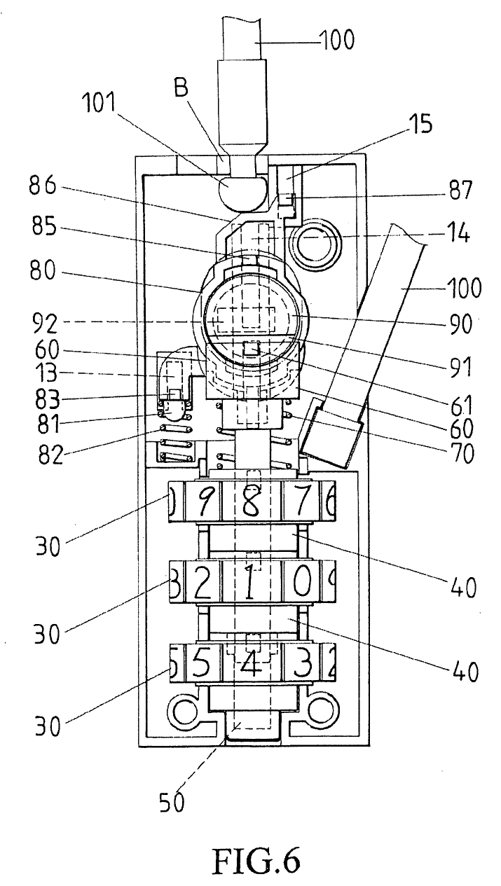

Referring to FIG. 6, the dials 30 are in a locked state and a key can be used to insert the key hole 92 of the tumbler 90 to rotate the tumbler 90 to open of the lock, the cutting 91 enabling the front end of the tongue 60 to be complaced, the block 80 is provided with space to be moved, if the cable 100 moving, the bolt 101 of the cable 100 is deviating the block 80 and squeezing the spring 82 (the spring 70 is not to be squeezed since the rod 50 is locked), the bolt 101 of the cable 100 can be moved the lock hole B of the housing 100 and to be leaved the housing 10.

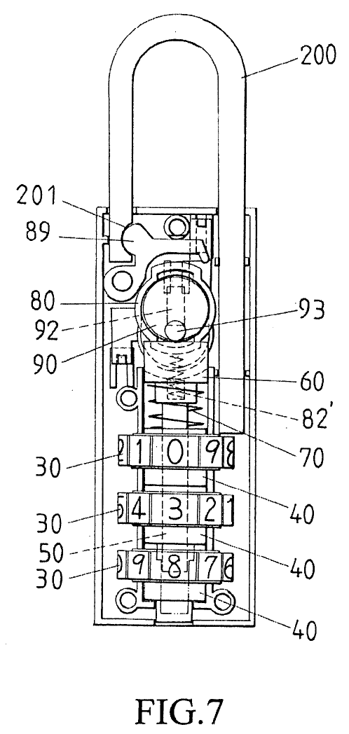

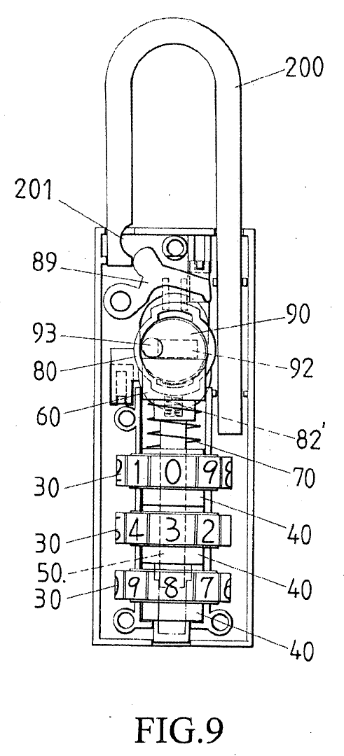

Referring to FIG. 7˜FIG. 9, it shows another preferred embodiment of the present invention, wherein a shackle 200 is instead of a cable in a housing 10, and the top end of the tumbler 90 is provided with a baffle block 93, and the top end of the block 80 is provided with a latch block 89, the front end of the tongue 60 is provided with a hole for install another spring 82′, and the top end of the spring 82′ can be touched the block 80.

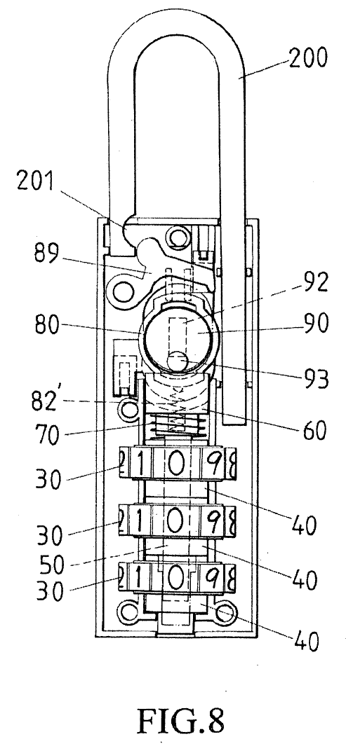

Referring to FIG. 7, the dials 30 are in a locked state and the stopper 93 of the tumbler 90 is locked on the top end of the tongue 60, and the latch 89 do not move and latched in the cavity 201 of the shackle 200 for locked. Referring to FIG. 8, the dials 30 are in an unlocked state and the tongue 60 enables to be pressed the spring 70, when the shackle 200 to be pulled upward, and the cavity 201 is no longer holding one end of the latch 89 and makes latch 89 to rotate, which causes the block 80 to be displaced downward, the end of the shackle 200 enables to be leaved the housing 10 and opening the lock. Referring to FIG. 9, the dials 30 are in a locked state and the tongue 60 can not be pressed the spring 70, the user enables key to insert the key hole 92 of the tumbler 90 to rotate, which the stopper 93 do not to be blocked the front end of the tongue 60, when the shackle 200 are in a pulled upward state, it enable to be rotated the latch 89, which causes the block 80 displace downward and pressing the spring 82′, the shackle 200 enables to pull upward all the way for opening the lock.

As is apparent from the foregoing, apart from the padlock of the present invention enabling the dials 30 of the housing 10 to open and close the lock, a key can also be used to rotate the tumbler 90 to enable force opening of the lock when the dials 30 are in a locked position.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A two-way opened padlock, can be unlocked either by a key or by a number dial, comprising a housing, the dials being placed into the housing, and an interior of the dials being provided with a center hole to allow the sleeves to insert, and an interior of the sleeves being provided with a center hole to allow the rod to pass therethrough; the dials are in an unlocked state and a rod which moves relative to the housing, and a block being provided with a tumbler and also can move relative to the housing, both the rod and the block can move in the same direction.

2. The two-way opened padlock in accordance with claim 1, wherein said housing is provided with a tongue and spring, a cable is latched in the cable hole of the housing, and the other end of cable is provided with a bolt for locked on the lock hole of the top end of the housing, and after a top end of the rod is sheathed with the spring, the rod is connected with a tongue, the tongue is provided with a bump.

3. The two-way opened padlock in accordance with claim 1, wherein a bump is located on the end of the block, the bump passes through the springs, the exterior sides of the block is provided with a slant surface.

4. The two-way opened padlock in accordance with claim 1, wherein said top end of the tumbler is provided with a cutting, and said other end of the tumbler is provided with a key hole.

5. The two-way opened padlock in accordance with claim 2, wherein said tongue is installed in the cutting of the tumble.

6. The two-way opened padlock in accordance with claim 1, wherein said housing is provided with a runner for rod displacing.

7. The two-way opened padlock in accordance with claim 1, wherein said interior of the housing is provided with a shackle to replace the cable, and sad top end of the tumbler is provided with a stopper, and said top end of the block is provided with a latch.

8. The two-way opened padlock in accordance with claim 2, wherein said front end of the tongue is provided with a hole for install a spring.
